(19) United States
(12) Patent Application Publication
(10) Pub. No.: US 2013/0271841 A1
(43) Pub. Date: Oct. 17, 2013

(54) RAMAN SCATTERING LIGHT ENHANCING DEVICE

(71) Applicants: Mitsuo Kawasaki, Kyoto-shi (JP); Yukihiro Morimoto, Himeji-shi (JP); Masahiro Kawasaki, Himeji-shi (JP); Yu Yamasaki, Himeji-shi (JP)

(72) Inventors: Mitsuo Kawasaki, Kyoto-shi (JP); Yukihiro Morimoto, Himeji-shi (JP); Masahiro Kawasaki, Himeji-shi (JP); Yu Yamasaki, Himeji-shi (JP)

(73) Assignee: USHIO DENKI KABUSHIKI KAISHA, Tokyo (JP)

(21) Appl. No.: 13/996,456

(22) PCT Filed: Dec. 19, 2011
(86) PCT No.: PCT/JP2011/079360

§ 371 Date: Jun. 20, 2013

(30) Foreign Application Priority Data
Dec. 22, 2010 (JP) 2010-285637

(51) Int. Cl. G02B 5/02

(52) U.S. Cl. CPC G02B 5/0284; B82Y 20/00
USPC 359/599; 977/834

(57) ABSTRACT

An object is to provide a Raman scattering light enhancing device that provides a sufficiently high Raman scattering light enhancing effect and produces a highly sensitive Raman signal even by using an excitation light source having a low energy density.

This Raman scattering light enhancing device includes a substrate, a high reflection layer that is formed on the substrate, a dielectric layer that is formed on the high reflection layer, and an enhanced electromagnetic field formation layer that is formed on the dielectric layer and includes a large number of fine silver particles. A gold film is formed on surfaces of the fine silver particles constituting the enhanced electromagnetic field formation layer.

### TECHNICAL FIELD

The present invention relates to a Raman scattering light enhancing device that uses surface enhanced Raman spectroscopy (SERS).

### BACKGROUND ART

Raman spectroscopy which includes irradiating an object to be analyzed with monochromatic light (laser light) and dispersing the resulting scattered light is used for substance identification etc. The Raman-scattered light obtained from an object to be analyzed is typically very weak and thus difficult to detect with high sensitivity.

In recent years, surface enhanced Raman spectroscopy (SERS) which utilizes localized surface plasmons of metal nanoparticles to excite an object to be analyzed adsorbed on the surfaces of the metal nanoparticles with laser light, thereby dramatically enhancing the resulting Raman-scattering light for detection, has been under research.

For example, Patent Literature 1 proposes an optical sensor (light enhancing device) that is configured so that a layer of silver nanoparticles and a smooth silver film (surface plasmon mirror) are opposed to each other with a dielectric film having a thickness of 40 nm or less interposed therebetween.

According to such an optical sensor, an enhanced electromagnetic field developed by the resonance between the localized surface plasmons of the silver nanoparticles and the surface plasmon polariton mode of the smooth silver film acts to produce a higher-order effect for enhancing the Raman signal. The metal nanoparticle layer with a regular periodical structure is described to provide an even higher enhancing effect.

### CITATION LIST

### Patent Literature

Patent Literature 1: Japanese Translation of PCT Application Publication No. 2007-538264

### SUMMARY OF INVENTION

### Technical Problem

Under the circumstances, the Raman analysis needs not only an improved analysis sensitivity but also a simplification of the Raman spectrometer.

The analysis sensitivity of the Raman signal has been improved to a certain level by the foregoing enhanced Raman scattering. However, the analytical instruments are extremely expensive because a high-output laser source is indispensable and other optical elements (including a microscope), a liquid nitrogen-cooled high sensitivity detector, and the like are needed as well. More specifically, Patent Literature 1 describes that the Raman signal (SERS signal) can be obtained by using laser light having power as extremely low as, e.g., approximately 0.4 μW (in terms of an enhancement ratio, up to 10¹⁴ times). Meanwhile, the analysis sensitivity is not evaluated by the power of the excitation laser light itself, but needs to be compared in terms of the irradiation power density. The foregoing laser light source actually needs to be a high-output one that has an excitation power density per irradiation area as high as approximately 13,000 mW/cm².

No Raman analysis apparatus satisfying the foregoing requirements has heretofore been known.

The present invention has been made on the basis of the foregoing circumstances and has as its object the provision of a Raman scattering light enhancing device that provides a sufficiently high Raman scattering light enhancing effect and can produce a highly sensitive Raman signal even by using an excitation light source having a low energy density (output).

### Solution to Problem

A Raman scattering light enhancing device according to the present invention includes a substrate, a high reflection layer that is formed on the substrate, a dielectric layer that is formed on the high reflection layer, and an enhanced electromagnetic field formation layer that is formed on the dielectric layer and includes a large number of fine silver particles, wherein

a thin gold film is formed on surfaces of the fine silver particles constituting the enhanced electromagnetic field formation layer.

In the Raman scattering light enhancing device according to the present invention, the dielectric layer may preferably have a thickness greater than or equal to an optical distance of nd=50 nm.

In the Raman scattering light enhancing device according to the present invention, the thin gold film may preferably be formed in a state that it covers an entire surface of the enhanced electromagnetic field formation layer.

In the Raman scattering light enhancing device according to the present invention, the high reflection layer may preferably be made of a metal selected from silver, gold, aluminum, and copper.

In the Raman scattering light enhancing device according to the present invention, a surface of the high reflection layer on a side of the dielectric layer may preferably be a roughened surface.

In the Raman scattering light enhancing device according to the present invention, the roughened surface may preferably have a surface roughness of Ra=10 to 30 nm.

In the Raman scattering light enhancing device according to the present invention, the enhanced electromagnetic field formation layer may preferably include a random arrangement of the fine silver particles.

In the Raman scattering light enhancing device according to the present invention, the fine silver particles may preferably be distributed at a density of 10⁸ to 10¹⁰ particles/cm² and each of them is randomly arranged in an independent state so as not to make contact with each other.

### Advantageous Effects of Invention

According to the Raman scattering light enhancing device of the present invention, the high reflection layer, the dielectric layer, and the enhanced electromagnetic field formation layer are basically formed on the substrate to constitute a multilayer structure, whereby a high enhanced electromagnetic field can be formed at positions near the individual fine silver particles constituting the enhanced electromagnetic field formation layer. This provides a sufficiently high Raman scattering light enhancing effect. In addition, even if an extremely low-output small-sized light source, like an LD (semiconductor laser diode) and an LED (light-emitting diode), is used as the excitation light source, the Raman signal can be reliably detected to achieve a high-sensitivity Raman analysis without using an expensive Raman spectroscopic apparatus.

If the Raman scattering light enhancing device of the present invention is used with an object to be analyzed (Raman active species) borne on the surface of the gold film directly or via an appropriate spacer, background noise (signal caused by fluorescence) can be reduced by the fluorescence quenching function of the gold film to obtain the Raman signal with a high S/N ratio.

Gold has excellent chemical stability. This prevents the problem that the object to be analyzed causes a chemical change (the object to be analyzed and silver form a compound) to complicate the interpretation of the analysis unless the object to be analyzed includes a gold film, for example. The Raman signal can be reliably detected even for such a reason.

The configuration that the gold film is formed in a state that it covers the entire surface of the enhanced electromagnetic field formation layer can prevent the fine silver particles from falling off. A desired function can thus be stably developed.

Moreover, the enhanced electromagnetic field formation layer itself need not have a structure (nanostructure) such that the light enhancing effect of localized surface plasmons becomes predominant. This eliminates structural constraints like those of a conventional light enhancing device, for example, that uses an interaction-based mechanism between localized surface plasmons of fine metal particles and surface plasmon polaritons lying between the fine metal particles and the high reflection layer as means for forming an enhanced electromagnetic field. The elimination of the structural constraints simplifies the structure itself, facilitates handling, and allows cost-advantageous fabrication.

### BRIEF DESCRIPTION OF DRAWINGS

FIG. 1 is a schematic diagram illustrating an overview of configuration in an example of the Raman scattering light enhancing device according to the present invention.

FIG. 2 is a schematic diagram for explaining a light enhancing mechanism in the Raman scattering light enhancing device according to the present invention.

FIG. 3 is an explanatory diagram illustrating an overview of the configuration of a measurement system constructed to measure Raman-scattered light in experimental examples.

FIG. 4 is a graph illustrating Raman spectra measured by using a Raman scattering light enhancing device fabricated in experimental example 1.

FIG. 5 is a graph illustrating Raman spectra measured by using a Raman scattering light enhancing device fabricated in experimental example 3.

### DESCRIPTION OF EMBODIMENTS

Hereinafter, an embodiment of the present invention will be described in detail.

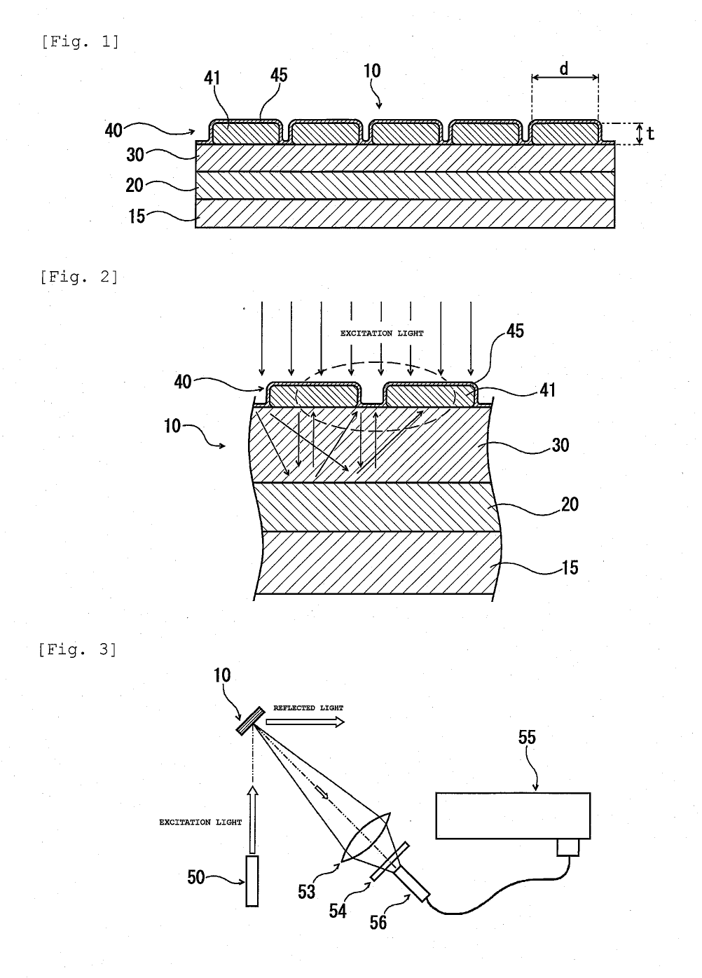

FIG. 1 is a schematic diagram illustrating an overview of configuration in an example of the Raman scattering light enhancing device according to the present invention.

A Raman scattering light enhancing device 10 according to this embodiment has a multilayer structure including, for example, a substrate 15 of flat plate shape, a high reflection layer 20 which is formed on the surface of the substrate 15, a dielectric layer 30 which is formed on the surface of the high reflection layer 20, and an enhanced electromagnetic field formation layer 40 which is formed on the surface of the dielectric layer 30 and includes a large number of fine silver particles 41. A thin gold film 45 is formed on the surface of the enhanced electromagnetic field formation layer 40. For example, this Raman scattering light enhancing device 10 enhances Raman-scattered light resulting from excitation light irradiation of an object to be analyzed (Raman active species) that is borne, directly or via a spacer, on the surface of areas of the gold film 45 lying on the surfaces of the fine silver particles 41.

The material of the substrate 15 is not limited in particular. As examples of the material of the substrate 15, may be mentioned glass, ceramics, resins, and metals. Heat-resisting materials such as glass and polyimide resins may preferably be used if a heating treatment (for example, heating to 200° C. or higher) is performed in the fabrication process of the Raman scattering light enhancing device 10 as will be described later.

The surface of the substrate 15 on the side of the high reflection layer 20 need not be a flat surface, and may be configured as a curved surface, a small spherical surface, etc.

The high reflection layer 20 may preferably be made of a material, for example, that has high reflectance across the entire visible region or at least in a wavelength range of 500 nm and above, specifically in the wavelength range of excitation light that excites the object to be analyzed. As specific examples of the material of the high reflection layer 20, may be mentioned silver, gold, aluminum, and copper.

The high reflection layer 20 may preferably have a thickness such that a reflectance of 90% or higher is obtained across the entire visible region or in a wavelength range of 500 nm and above.

The surface of the high reflection layer 20 on the side of the dielectric layer 30 may be an optically smooth surface, whereas it may preferably be a roughened surface. Specifically, the roughened surface may preferably have a surface roughness Ra of, e.g., approximately 10 to 30 nm. This provides an even higher light enhancing effect as shown by the results of experimental examples to be described later.

The dielectric layer 30 is made of a material transparent to the excitation light. The dielectric layer 30 may preferably be made of a heat-resisting material if a heating treatment (for example, heating to 200° C. or higher) is performed in the fabrication process of the Raman scattering light enhancing device 10 as will be described later. As specific examples of the material of the dielectric layer 30, may be mentioned SOG (Spin on Glass) materials composed mainly, of silicon oxide, and siloxane materials including tetraethoxysilane (TEOS) and dimethylsiloxane. If the dielectric layer 30 is made of a cured film (SOG film) obtained by curing a SOG material, an alkali- or plasma-based hydrophilic treatment may preferably be applied as appropriate because the surface of the SOG film has relatively high hydrophobicity.

The dielectric layer 30 may preferably have a thickness greater than or equal to an optical distance of nd=50 nm, more preferably 60 to 90 nm. If the thickness of the dielectric layer 30 is too small, a sufficient light enhancing effect cannot be obtained as shown by the results of the experimental examples to be described later.

The enhanced electromagnetic field formation layer 40 may preferably be made of a monolayer film of a large number of fine silver particles 41.

Fine silver particles 41 having a size smaller than or equal to the wavelength of the excitation light, such as a cross-sectional particle diameter (horizontal dimension in FIG. 1) d of 30 to 400 nm and a thickness t of 5 to 70 nm, and shape anisotropy, like a flat spherical shape and a flat plate-like shape, may be suitably used. The fine silver particles 41 may preferably have uniform size and shape, whereas some variations in size and shape may be allowed.

In the enhanced electromagnetic field formation layer 40, the fine silver particles 41 having the foregoing size (cross-sectional particle diameter and thickness) may preferably be distributed, for example, two-dimensionally at random, specifically at a density of, e.g., 10⁸ to 10¹⁰ particles/cm², and arranged in an independent state so as not to make contact with each other.

The enhanced electromagnetic field formation layer 40 may include a regular arrangement of the fine silver particles 41.

A formation process of such an enhanced electromagnetic field formation layer 40 is not limited in particular. For example, a process of applying by spin coating and heating a dispersion liquid including fine silver particles dispersed in an appropriate solvent, a process of dipping and heating the same, and a process of vacuum depositing the same may be suitably used.

The Raman scattering light enhancing device 10 according to this embodiment is configured so that the gold film 45 is formed in a state that it covers the entire surface of the enhanced electromagnetic field formation layer 40. However, the gold film 45 has only to be formed at least on the outer surfaces (surfaces to be irradiated with the excitation light) of the fine silver particles 41. The enhanced electromagnetic field formation layer may be made of composite fine metal particles having a core-shell structure, for example, where the surfaces of fine silver particles (core particles) are covered with a gold coating.

The gold film 45 may preferably have a thickness of, for example, 4% to 10% the thickness t of the fine silver particles 41. Specifically, the gold film 45 may preferably have a thickness of 2 to 5 nm if the size of the fine silver particles 41 is in the foregoing numerical ranges.

Such a gold film 45 may be formed by sputtering, for example.

When using this Raman scattering light enhancing device 10, as described above, the object to be analyzed is borne directly or via an appropriate spacer on the surface of the areas of the gold film 45 lying on the surfaces of the fine silver particles 41. To obtain the Raman signal with a high S/N ratio, the object to be analyzed may preferably be borne directly on the surface of the gold film 45.

Then, Raman scattering light emitted from an object to be analyzed which is irradiated and excited with excitation light is detected by an appropriate spectrometer.

The spacer is intended to adjust the distance between the surface of the gold film 45 and the object to be analyzed. For example, the spacer may be made of a dielectric such as a SOG film.

The spacer may preferably have a thickness of 10 nm or less. In particular, thicknesses of 1 nm and less maximize the Raman scattering light enhancing effect.

According to the Raman scattering light enhancing device 10 described above, the high reflection layer 20, the dielectric layer 30, and the enhanced electromagnetic field formation layer 40 are basically formed on the substrate 15 to constitute the multilayer structure, whereby a high enhanced electromagnetic field can be formed at positions near the individual fine silver particles 41 constituting the enhanced electromagnetic field formation layer 40. This provides a sufficiently high Raman scattering light enhancing effect as is clear from the results of the experimental examples to be described later. A possible reason is that as illustrated in FIG. 2, an interference field where a positive interference occurs between the excitation light and the reflection light of the excitation light from the high reflection layer 20 is formed at the positions near the individual fine silver particles 41 constituting the enhanced electromagnetic field formation layer 40, and the interference field acts to further enhance the enhanced electromagnetic field (the area surrounded by the broken line in FIG. 2) resulting from localized surface plasmons of the fine silver particles 41. However, such a well-known interference effect alone cannot fully explain a high Raman enhancement ratio seen in the experimental examples in particular. It is resumed that an electromagnetic field radiated from the localized surface plasmons of the fine silver particles 41 probably undergoes self-amplifying higher-order enhancement in the presence of the high reflection layer 20, eventually causing a high enhanced electromagnetic field far beyond the conventional wisdom.

In addition, even if an extremely low-output small-sized light source, like an LD (semiconductor laser diode) and an LED (light-emitting diode), is used as the excitation light source, a desired Raman signal can be reliably obtained. Specifically, for example, a Raman spectrum of a Raman active species can be measured even when low-output laser light having an energy density of 10 mW/cm² or less is used as the excitation light. A desired Raman spectroscopic analysis can thus be performed with an extremely simple instrument like the measurement system used in the experimental examples to be described later.

Since the Raman scattering light enhancing device 10 is used with the object to be analyzed borne on the surface of the gold film 45, background noise (signal caused by fluorescence) can be reduced by the fluorescence quenching function of the gold film 45 to obtain a Raman signal with a high S/N ratio.

Gold has excellent chemical stability, which prevents the problem that the object to be analyzed causes a chemical change (the object to be analyzed and silver form a compound) to complicate the interpretation of the analysis unless the object to be analyzed includes a gold film, for example. The Raman signal can be reliably detected even for such a reason.

The configuration that the gold film 45 is formed in a state that it covers the entire surface of the enhanced electromagnetic field formation layer 40 can prevent the fine silver particles 41 from falling off. A desired function can thus be stably developed.

The fine silver particles 41 have shape anisotropy and uniform particle diameters, and the gold film 45 is formed on the outer surfaces of the fine silver particles 41. With such a configuration, the wavelength characteristic (resonant wavelength) can be adjusted by adjusting the thickness of the gold film 45 according to the thickness (height) of the fine silver particles 41. A desired Raman scattering light enhancing effect can thus be obtained over a wide range of wavelengths.

Moreover, the enhanced electromagnetic field formation layer itself need not have the structure (nanostructure) that the light enhancing effect of localized surface plasmons becomes predominant. This eliminates structural constraints like those of a conventional light enhancing device, for example, that uses an interaction-based mechanism between localized surface plasmons of fine metal particles and surface plasmon polaritons lying between the fine metal particles and the high reflection layer as means for forming the enhanced electromagnetic field. The elimination of the structural constraints simplifies the structure itself, facilitates handling, and allows cost-advantageous fabrication.

Hereinafter, experimental examples that were conducted to confirm the effect of the Raman scattering light enhancing device according to the present invention will be described.

### Experimental Example 1

### Fabrication of Raman Scattering Light Enhancing Device (10)

A 1-cm-square glass slide was used as the substrate (15). A silver film serving as the high reflection layer (20) was formed on the surface of the glass slide by ordinary resistive heating vacuum deposition. The resulting silver film had a thickness of 0.2 μm or more, with substantially zero transmittance in the visible region. The actual measured reflectance showed a high reflectance of 98% or higher in almost the entire visible region, which coincides with a value theoretically calculated by using the optical constants of bulk silver.

Next, a commercially available dimethylsiloxane solution, appropriately diluted with ethanol, was spin coated onto the roughened surface (top surface) of the silver film at 3000 rpm, followed by several minutes of heating treatment on a hot plate of 200° C. to 250° C. to form a dielectric film (refractive index of 1.3 to 1.4) serving as the dielectric layer (30). The dielectric film had a thickness of approximately 80 nm. A plasma-based hydrophilic treatment was then applied to the surface (top surface) of the resulting dielectric film.

Next, an acetonic dispersion liquid of protective layer-free silver nanoparticles (concentration of approximately 0.4% by weight; volumetric average particle diameter of approximately 15 nm) was spin coated onto the hydrophilic-treated surface (top surface) of the dielectric film at 3000 rpm, followed by several minutes of heating on a hot plate of approximately 250° C. to form an ultra-fine silver particle monolayer film serving as the enhanced electromagnetic field formation layer (40). The ultra-fine silver particles in the resulting ultra-fine silver particle monolayer film had an average cross-sectional particle diameter (d) of approximately 150 nm and an average thickness (t) of approximately 30 nm. The ultra-fine silver particles were arranged two-dimensionally at random as distributed at a density of 10⁸ to 10¹⁰ particles/cm². The ultra-fine silver particles were confirmed by XRD (X-ray diffraction) measurement to have crystallinity as high as bulk silver.

The gold film (45) was then formed on the surface of the ultra-fine silver particle monolayer film by sputtering under the following condition.

<Sputtering Condition>

An ion sputtering apparatus “JFC-1100” (manufactured by JEOL Ltd.) was used. The substrate was placed so that the distance from an Au target to the surface of the dielectric film was 40 mm. The atmosphere was Ar: 0.15 Torr. The discharge current was 7 to 8 mA. The target voltage was −0.7 kV. The duration was one to two minutes.

[Fabrication of Raman Scattering Light Enhancing Device for Comparison]

A Raman scattering light enhancing device for comparison having the same configuration as that of the foregoing Raman scattering light enhancing device except having no gold film was fabricated by the same method as the foregoing except that the gold film was not formed on the surface of the ultra-fine silver particle monolayer film in the fabrication process of the foregoing Raman scattering light enhancing device.

[Bearing of Sample (Object to be Analyzed)]

A dilute ethanol solution of rhodamine 6G (Rh6G) dye was spin coated onto the surface of the gold film of the Raman scattering light enhancing device at 3000 rpm so that dye molecules were borne on the surface of the gold film. The relationship between the density of the dye molecules borne on the surface of the Raman scattering light enhancing device and the dye concentration of the solution used in the spin coating was such that the dye molecules have a density of 7×10¹³ molecules/cm² when the concentration of the Rh6G is 0.3 mM. By the same method, dye molecules were borne on the surface of the ultra-fine silver particle monolayer film of the Raman scattering light enhancing device for comparison.

[Measurement of Raman-Scattered Light]

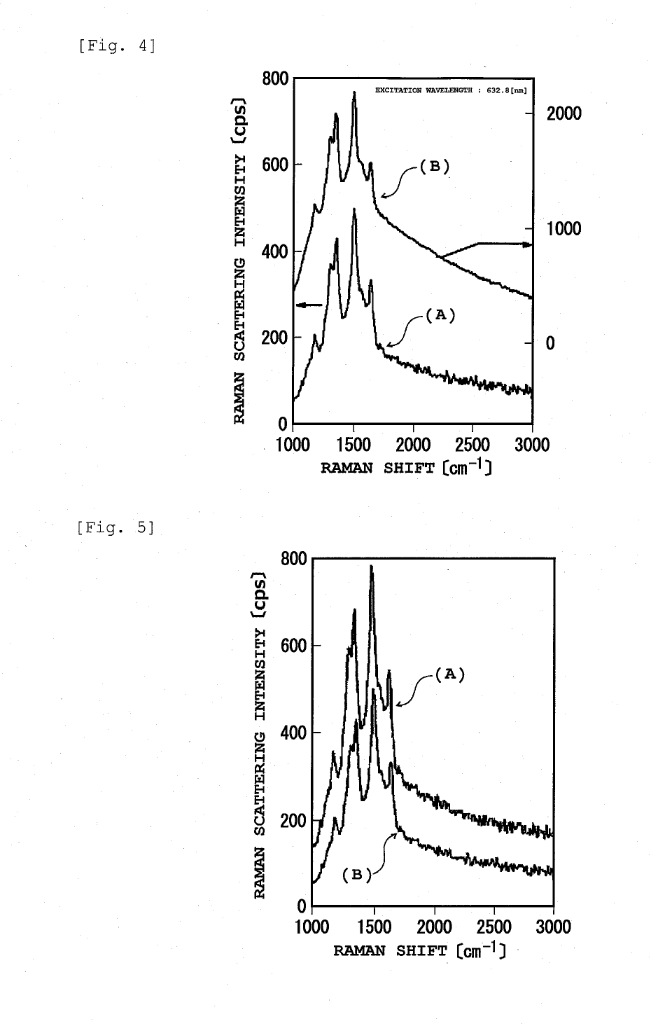

The Raman scattering light enhancing device and the Raman scattering light enhancing device for comparison fabricated as described above were each measured for Raman-scattered light emitted from the sample (dye molecules) irradiated with the excitation light in a measurement system configured as illustrated in FIG. 3. FIG. 4 illustrates the results. In FIG. 4, the curve (A) indicates the result of the Raman scattering light enhancing device according to the present invention (with the gold film). The curve (B) indicates the result of the Raman scattering light enhancing device for comparison.

In FIG. 3, the reference sign 50 designates a He—Ne laser (wavelength of 632.8 nm) with an output below 1 mW, which was used as the excitation light source. The He—Ne laser irradiates the Raman scattering light enhancing device 10 with unfocused (energy density of approximately 300 mW/cm²) or defocused (energy density of approximately 10 mW/cm²) excitation light through a filter (not illustrated). In this measurement system, the Raman scattering light enhancing device 10 was rotatably arranged so that the incident angle of the excitation light could be set. To measure Raman-scattered light, the excitation light was made incident on the Raman scattering light enhancing device 10 at an incident angle of 45°. The Raman-scattered light scattered in the angular direction of 90° by the dye borne on the Raman scattering light enhancing device 10 was concentrated by a condenser lens (aperture of 35 mm) 53 located at a distance of approximately 13 cm from the surface of the Raman scattering light enhancing device 10, onto a photoreceptor head 56 of an electronically-cooled diode array detector 55 through a filter 54.

As is clear from the results illustrated in FIG. 4, according to the Raman scattering light enhancing device of the present invention, the detected signal was low in level (absolute value) as compared to that of the Raman scattering light enhancing device for comparison. It was confirmed, however, that the resulting Raman signal had a higher S/N ratio.

### Experimental Example 2

Based on the Raman scattering light enhancing device fabricated in experimental example 1, six Raman scattering light enhancing devices with a dielectric layer adjusted in thicknesses according to the following table 1 were fabricated by the same method as in experimental example 1. The six Raman scattering light enhancing devices were measured for Raman-scattered light (Raman scattering intensity) by the same method as in experimental example 1. The following table 1 shows the results.

The thicknesses of the dielectric films were adjusted as appropriate based on the relationship (calibration curve) between the solution concentration used in the spin coating and the thickness of the transparent dielectric film to form, actually measured by AFM-based step measurement. If the commercially available dimethylsiloxane solution undiluted is spin coated, the resulting maximum thickness is 180 nm. To form dielectric films with large thicknesses, the foregoing processing was repeated a plurality of times.

TABLE 1

| THICKNESS OF | RAMAN SCATTERING |
|---|---|
| DIELECTRIC FILM | INTENSITY |
| [nm] | [cps] |
| 10 | 0 |
| 50 | 170 |
| 80 | 200 |
| 100 | 130 |
| 300 | 100 |
| 500 | 70 |

As is clear from the above results, a high Raman scattering light enhancing effect was confirmed to be obtained if the dielectric layer had a thickness of 50 nm or more.

### Experimental Example 3

A Raman scattering light enhancing device having the same configuration as that of the Raman scattering light enhancing device according to experimental example 1 was fabricated by the same method as the foregoing except that a heating-based roughening treatment was applied to the surface of the silver film (high reflection layer) on the side of the dielectric layer to optically roughen the surface in the fabrication process of the Raman scattering light enhancing device of experimental example 1. According to AMF measurement, the surface of the silver film had a surface roughness Ra of approximately 10 to 30 nm.

Raman-scattered light (Raman scattering intensity) was then measured by the same method as in experimental example 1. FIG. 5 illustrates the results. In FIG. 5, the curve (A) indicates the result of the light enhancing device having the high reflection layer with the roughened surface. The curve (B) indicates the result of the light enhancing device having the high reflection layer with the optically smooth surface (fabricated in experimental example 1).

As is clear from the above results, roughening the surface of the silver film (high reflection layer) on the side of the dielectric film was confirmed to increase the Raman scattering intensity (Raman signal) for an even higher enhancing effect as compared to the Raman scattering light enhancing device having the structure that the surface of the silver film optically smooth.

### REFERENCE SIGNS LIST

10 Raman scattering light enhancing device
15 substrate
20 high reflection layer
30 dielectric layer
40 enhanced electromagnetic field formation layer
41 fine silver particle
45 gold film
50 He—Ne laser
53 condenser lens
54 filter
55 electronically-cooled diode array detector
56 photoreceptor head

1-8. (canceled)

9. A Raman scattering light enhancing device comprising a substrate, a high reflection layer that is formed on said substrate, a dielectric layer that is formed on said high reflection layer, and an enhanced electromagnetic field formation layer that is formed on said dielectric layer and includes a large number of fine silver particles, wherein
a gold film is formed on surfaces of the fine silver particles constituting said enhanced electromagnetic field formation layer, and a Raman signal having a high S/N ratio is obtained by a fluorescence quenching function of said gold film.

10. The Raman scattering light enhancing device according to claim 9, wherein said dielectric layer has a thickness greater than or equal to an optical distance of nd=50 nm.

11. The Raman scattering light enhancing device according to claim 9, wherein said gold film is formed in a state that it covers an entire surface of said enhanced electromagnetic field formation layer.

12. The Raman scattering light enhancing device according to claim 9, wherein said high reflection layer is made of a metal selected from silver, gold, aluminum, and copper.

13. The Raman scattering light enhancing device according to claim 9, wherein a surface of said high reflection layer on a side of said dielectric layer is a roughened surface.

14. The Raman scattering light enhancing device according to claim 13, wherein the roughened surface has a surface roughness of Ra=10 to 30 nm.

15. The Raman scattering light enhancing device according to claim 9, wherein said enhanced electromagnetic field formation layer includes a random arrangement of said fine silver particles.

16. The Raman scattering light enhancing device according to claim 15, wherein the fine silver particles are distributed at a density of 10⁸ to 10¹⁰ particles/cm² and each of them is randomly arranged in an independent state so as not to make contact with each other.

17. The Raman scattering light enhancing device according to claim 10, wherein said gold film is formed in a state that it covers an entire surface of said enhanced electromagnetic field formation layer.

18. The Raman scattering light enhancing device according to claim 10, wherein said high reflection layer is made of a metal selected from silver, gold, aluminum, and copper.

19. The Raman scattering light enhancing device according to claim 10, wherein a surface of said high reflection layer on a side of said dielectric layer is a roughened surface.

20. The Raman scattering light enhancing device according to claim 19, wherein the roughened surface has a surface roughness of Ra=10 to 30 nm.

21. The Raman scattering light enhancing device according to claim 10, wherein said enhanced electromagnetic field formation layer includes a random arrangement of said fine silver particles.

22. The Raman scattering light enhancing device according to claim 21, wherein the fine silver particles are distributed at a density of 10⁸ to 10¹⁰ particles/cm² and each of them is randomly arranged in an independent state so as not to make contact with each other.
